(19) United States
(12) Patent Application Publication
(10) Pub. No.: US 2026/0177146 A1
(43) Pub. Date: Jun. 25, 2026

(54) SEALING STRUCTURE WITH GASKET AND METHOD OF MANUFACTURING THE SAME

(71) Applicant: DENSO WAVE INCORPORATED, Chita-gun (JP)

(72) Inventor: Masaki FURUKAWA, Chita-gun (JP)

(73) Assignee: DENSO WAVE INCORPORATED, Chita-gun (JP)

(21) Appl. No.: 19/430,550

(22) Filed: Dec. 23, 2025

(30) Foreign Application Priority Data
Dec. 23, 2024 (JP) 2024-226250

(51) Int. Cl. F16J 15/14; F16J 15/06

(52) U.S. Cl. CPC F16J 15/14; F16J 15/062

(57) ABSTRACT

In a sealing structure, a first component and a second component are sealed with each other with a cured liquid gasket formed on the first member and compressed between the first and second components. The first component is provided with a liquid-repellent portion which is subjected to liquid-repellent processing and a non-liquid-repellent portion which is not subjected to the liquid-repellent processing. The cured liquid gasket is in touch with both the cured and non-cured repellent portions. The sealing structure is capable of suppressing variations in the thickness of the cured liquid gasket, thereby improving sealing performance.

### CROSS-REFERENCE TO RELATED APPLICATION

This application is based on and claims the benefit of priority from earlier Japanese Patent Application No. 2024-226250 filed Dec. 23, 2024, the description of which is incorporated herein by reference.

### BACKGROUND

### Technical Field

The present invention relates to a sealing structure with a gasket and a method of manufacturing a sealing structure with a gasket, and in particular, to a sealing structure with a liquid gasket to be cured and compressed and a method of manufacturing a sealing structure with a liquid gasket to be cured and compressed.

### Background Art

A curable liquid composition can be applied to a desired location and cured in situ to form a gasket. Such a type of liquid gasket is widely employed in many applications. As shown in Patent Document 1, this gasket functions as a sealing member.

### PATENT PRIOR ART REFERENCE

[PTL] JP 2020-70866 A1

### Technical Problem

In the process for forming the liquid gaskets, after applying a curable liquid composition to the coating surface of a component, the applied curable liquid composition may spread across the coating surface before being cured, resulting in variations in the height (thickness) of the curable composition. In this case, variations in the thickness occur in the liquid gasket formed by the cured curable liquid composition (hereinafter, referred to as the “cured liquid gasket”). Consequently, when compressing and sealing the cured liquid gasket, areas may arise where sufficient compression cannot be achieved, thus being led to reduced sealing performance.

### SUMMARY

It is thus required to provide the sealing structure which is able to reduce variations in the thickness of the cured liquid gasket, thus providing the sealing structure with higher sealing performance.

With consideration of the current situations, a first aspect of the disclosure provides a sealing structure provided for a first component and a second component such that the first and second components are sealed by being tightly contacted with each other, wherein
the first component is provided with a cured liquid gasket, the cured liquid gasket being compressed between the first and second components,
the first component is provided with a liquid-repellent portion which is subjected to liquid-repellent processing and a non-liquid-repellent portion which is not subjected to the liquid-repellent processing, and
the cured liquid gasket is in touch with both the liquid-repellent portion and the non-liquid-repellent portion when being compressed.

In this configuration, the cured liquid gasket is formed by applying the curable liquid composition to the first component and then being cured. The liquid gasket which has been cured is compressed between the first and second components, thereby providing a sealing performance between the first and second components.

The first component has the liquid-repellent portion on which liquid-repellent processing is applied. In this structure, the cured liquid gasket is in touch with the liquid-repellent portion, so that when the curable liquid composition is applied to the first component, the curable composition which comes contact with the liquid-repellent portion is repelled by the liquid-repellent portion.

Hence, during a period the curing process of the applied curable liquid composition has been completed, the curable liquid composition is suppressed from spreading on the surface of the first component, thus making it possible to reduce variations in the height of the curable composition. This results in suppression or reduction of variations in the thickness of the liquid gasket which has been cured, whereby the cured liquid gasket can be compressed evenly, in area, between the first and second components. Accordingly, the sealing structure, applied between the first and second components, has a higher searing performance.

In addition, the first component has the non-liquid-repellent portion which is not subjected to the liquid-repellent processing. The cured liquid gasket is also in touch with the non-liquid-repellent portion. As a result, in the cured liquid gasket compressed between the first and second components, the contact between the non-liquid-repellent portion and the cured liquid gasket can be made higher even when the contact between the liquid-repellent portion and the cured liquid gasket is reduced. Accordingly, it is possible to suppress the cured liquid gasket from moving to and from the first component, whereby the cured liquid gasket can be compressed fully between the first and second components to provide a secure and reliable sealing performance.

Preferably, in the first mode, the second component is provided with a portion which compresses the cured liquid gasket, the portion including, at least, a part which is not subjected to the liquid-repellent processing. As a result, the at least part of such a portion of the second component and the cured liquid gasket can be highly and tightly contacted with each other, thus preventing or suppressing the cured liquid gasket from moving relative to the second component. Hence, the cured liquid gasket can be sufficiently compressed between the first component and the second component, ensuring the sealing performance of the sealing structure.

Still preferably, the first component is formed with a groove-shaped recess thereon, the cured liquid gasket has a part which is disposed in the recess and a remaining part which is disposed outside the recess, and the recess has a concave surface at least a part of which is formed with the non-liquid-repellent portion.

Accordingly, even when the cured liquid gasket attempts to move relative to the first component, such a portion of the cured liquid gasket positioned in the recess becomes caught in the recess, thereby suppressing or preventing movement of the cured liquid gasket. Namely, against the movement, a kind of wedging effect is gained by the portion of the cured liquid gasket which is positioned in the recess.

In addition, the non-liquid-repellent portion is formed on at least part of the concave surface of the recess. Hence, when being compared to a case where the non-liquid-repellent portion is formed on a flat surface, the spread of the applied curable liquid composition over the surface of the first component can be suppressed. Thus, variations in the height of the curable composition, and consequently variations in the thickness of the cured liquid gasket, can be further suppressed.

Moreover, when determining the position for applying the curable liquid composition, the groove-shaped recess can be used as positioning means, thus enabling improved workability during application.

It is preferred that the recess has an opening of which peripheral edge portion is formed with the liquid-repellent portion. According to this configuration, when applying the curable liquid composition as the first component, the portion of the curable liquid composition that drips outside the recess is more readily repelled by the liquid-repellent portion formed on the peripheral edge portion of the opening of the recess. Consequently, the height of the curable liquid composition is reduced, thereby suppressing variations in its height and further limiting variations in the thickness of the cured liquid gasket.

In the foregoing, the concave surface has a V-shape in section with a longitudinal circulating direction along the recess, and the concave surface is wholly formed with the non-liquid-repellent portion. This configuration also enables the application of the curable liquid composition to minimize the amount of the curable composition flowing into the recess while ensuring sufficient contact area between the cured liquid gasket and the non-liquid-repellent portion. Hence, it is also possible to suppress movement of the cured liquid gasket while further reducing the height of the curable liquid composition, thereby further suppressing variations in the height of the curable composition.

As an example, the concave surface has a bottom surface and side surfaces, the bottom surface is formed with the non-liquid-repellent portion, and the side surfaces are formed with the liquid-repellent portion.

According to this configuration, since the non-liquid-repellent portion is formed on the bottom surface of the concave surface, the spread of the applied curable liquid composition over the surface of the first component can be suppressed, compared to a case where the non-liquid-repellent portion is formed on a flat surface. Furthermore, as the liquid-repellent portion is formed on the side surface of the concave surface, when applying the curable liquid composition to the first component, the curable liquid composition is more readily repelled by the liquid-repellent portion formed on the side surface of the concave surface. As a result, the height of the curable composition can be further suppressed, thereby further suppressing variations in the height of the curable composition and further suppressing variations in the thickness of the cured liquid gasket.

As another example, the concave surface has a bottom surface and side surfaces, the bottom surface is formed with the liquid-repellent portion, and the side surfaces are formed with the non-liquid-repellent portion.

In this configuration, the liquid-repellent portion is formed on the bottom surface of the concave surface. Thus, applying the curable liquid composition to the bottom surface of the concave surface makes it easier for the liquid-repellent portion to repel the curable liquid composition. The height of the curable composition can be reduced, thereby suppressing variations in the height of the curable composition and preventing or reducing variations in the thickness of the cured liquid gasket. Furthermore, as the non-liquid-repellent portion is formed on the side surface of the concave surface, when the cured liquid gasket attempts to move relative to the first component, a portion of the compressed cured liquid gasket adheres to the non-liquid-repellent portion formed on the side surface of the concave surface, thereby suppressing movement of the cured liquid gasket, thanks to a kind of wedging effect.

As another preferable example, the first component has a first portion and a second portion, the first portion being opposed to the cured liquid gasket in a first direction along which the cured liquid gasket is compressed, the second portion being bent and extended from the first portion and opposed to the cured liquid gasket in a second direction perpendicular to the second direction, the liquid repellent portion is formed on the first portion, and the non-liquid repellent portion is formed on the second portion.

According to this configuration, in the cured liquid gasket compressed between the first component and the second component, even if the adhesion between the liquid-repellent portion formed in the first part and the cured liquid gasket is reduced, the adhesion between the non-liquid-repellent portion formed in the second part and the cured liquid gasket can be maintained at a high level. Consequently, movement of the cured liquid gasket relative to the first component can be suppressed or prevented in a reliable manner, thus enabling the cured liquid gasket to be sufficiently compressed between the first and second components to ensure a higher-level sealing performance.

As a second aspect of the disclosure, there is provided a sealing method which manufactures a sealing structure having a contact between a first component and a second component such that the first and second components are mutually sealed, the sealing method comprising steps of:
forming, on the first component, a liquid repellent portion which is subjected to liquid-repellent processing and a non-liquid repellent portion which is not subjected to the liquid-repellent processing;
applying a liquid curable composition to a predetermined area including, at least, a part of the liquid repellent portion on the first component;
curing the applied curable composition to from the cured liquid gasket;
compressing the cured liquid gasket between the first and second components such that the non-liquid repellent portion is tightly in touch with the cured liquid gasket.

In this sealing method, the liquid curable composition is applied to a predetermined area including, at least, the part of the liquid repellent portion on the first component. Thanks to this application, the curable composition in contact with the liquid-repellent portion is repelled by the liquid-repellent portion. Thus, it is possible to suppress or prevent the spread of the applied curable liquid composition across the surface of the first component before curing, thereby preventing or reducing variations in the height of the curable composition.

The applied curable composition is then cured to form the cured liquid gasket. As variations in the height of the curable composition are suppressed or reduced, variations in the thickness of the cured liquid gasket can also be suppressed or reduced.

The cured liquid gasket is then compressed between the first component and the second component, thereby adhering the cured liquid gasket to the non-liquid-repellent portion.

Thus, variations in the thickness of the cured liquid gasket are suppressed or reduced, enabling the cured liquid gasket to be uniformly compressed between the first component and the second component, thereby improving the sealing performance of the sealing structure. Additionally, even if the adhesion between the liquid-repellent portion and the cured liquid gasket deteriorates, the adhesion between the non-liquid-repellent portion and the cured liquid gasket can be maintained at a high level. As a result, movement of the cured liquid gasket relative to the first component can be suppressed or prevented, enabling the cured liquid gasket to be sufficiently compressed between the first and second components to ensure a higher-level sealing performance.

Preferably, the foregoing sealing method can include steps of:
forming a groove-shaped recess on the first component, the recess having a concave surface,
forming the non-liquid repellent portion on, at least, the concave surface of the recess, and
applying the liquid curable composition to the predetermined area including, at least, the part of the non-liquid repellent portion.

According to these steps, the non-liquid-repellent portion is formed on at least part of the concave surface of the groove-shaped recess, and the curable liquid composition is applied within the predetermined range containing the non-liquid-repellent portion. Hence, the groove-shaped recess can be utilized as positioning means when determining the position for applying the curable liquid composition, thereby improving the workability during application. Furthermore, compared to when the non-liquid-repellent portion is formed on a flat surface, the spread of the applied curable liquid composition over the surface of the first component can be suppressed. Consequently, variations in the height of the curable composition, and consequently variations in the thickness of the cured liquid gasket, can be further suppressed.

As an example, the sealing method may include a step of forming the liquid repellent portion on a peripheral edge portion of an opening of the recess. According to this step, when applying the curable liquid composition to the first component, the portion of the curable liquid composition that drips outside the recess is more readily repelled by the liquid-repellent portion formed on the peripheral edge portion of the opening of said recess. Thus, the height of the curable composition is reduced, thereby suppressing or preventing variations in the height of the curable composition and further suppressing or preventing variations in the thickness of the cured liquid gasket.

As a third aspect of the disclosure, there can also be provided an electric apparatus, comprising:
a first component provided with a space, an electronic device being housed in the space; and
a sealing structure provided for the first component and the second component such that the first and second components are sealed by being tightly contacted with each other, wherein
the first component is provided with a cured liquid gasket, the cured liquid gasket being compressed between the first and second components,
the first component is provided with a liquid-repellent portion which is subjected to liquid-repellent processing and a non-liquid-repellent portion which is not subjected to the liquid-repellent processing, and
the cured liquid gasket is in touch with both the liquid-repellent portion and the non-liquid-repellent portion when being compressed.

This third aspect can be developed into various modifications as those developed from the first aspect, so that the third aspect and their modified examples are also able to have the same or equivalent advantageous operations and effects as or to those gained from the first and its modified various examples.

### BRIEF DESCRIPTION OF DRAWINGS

In the accompanying drawings:

FIG. 1 provides illustrations explaining the body of a PLC I/O case and a lid, to which a sealing structure according to the present disclosure is applied.

FIG. 2 is a pictorial illustration explaining how a curable liquid composition is applied to the surface formed on a member which is according to the prior art.

FIG. 3 is a pictorial illustration explaining how the curable liquid composition is spread out on the surface formed on the member which is according to the prior art.

FIG. 4 is a pictorial illustration explaining how the cured liquid gasket is compressed, which is according to the prior art technique.

FIG. 5 is a pictorial illustration explaining how a curable liquid composition is applied to a liquid-repellent layer according to a comparative example.

FIG. 6 is a microscope photograph exemplifying, in an enlarged view, water-repellent graining.

FIG. 7 is a pictorial illustration explaining how a cured liquid gasket, which is according to a comparative example, is compressed.

FIG. 8 is a pictorial illustration explaining how the cured liquid gasket, which is according to the comparative example, is moved.

FIG. 9 is a partial sectional view showing a sealing structure according to a first embodiment, in which FIG. 9 is taken along a line IX-IX drawn in FIG. 1.

FIG. 10 is a flowchart explaining how the sealing structure is manufactured.

FIG. 11 is a partial sectional view showing a sealing structure according to a modification of the first embodiment, in which FIG. 11 is taken along the line IX-IX drawn in FIG. 1.

FIG. 12 is a partial sectional view showing a sealing structure according to another modification of the first embodiment, in which FIG. 12 is taken along the line IX-IX drawn in FIG. 1.

FIG. 13 is a partial sectional view showing a sealing structure according to a second embodiment, in which FIG. 13 is also taken along the line IX-IX drawn in FIG. 1.

FIG. 14 is a partial sectional view showing a cured liquid gasket according to a third embodiment.

FIG. 15 is a partial sectional view showing a sealing structure according to the third embodiment, in which FIG. 15 is also taken along the line IX-IX drawn in FIG. 1.

FIG. 16 is a partial sectional view showing a cured liquid gasket according to a fourth embodiment.

FIG. 17 is a partial sectional view showing a sealing structure according to the fourth embodiment, in which FIG. 17 is also taken along the line IX-IX drawn in FIG. 1.

FIG. 18 is a partial sectional view showing a sealing structure according to a modification of the fourth embodiment.

FIG. 19 is a partial sectional view showing a sealing structure according to another modification of the fourth embodiment.

### DESCRIPTION OF THE PREFERRED EMBODIMENTS

### First Embodiment

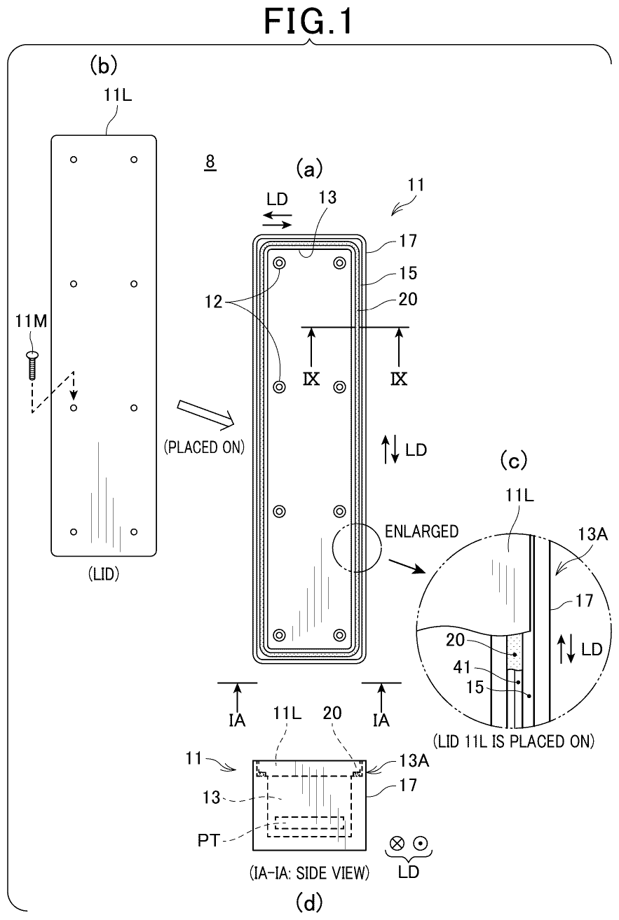

With reference to FIGS. 1 to 10 of the accompanying drawings, a first embodiment practiced into a shealing structure for a PLC (Programmable Logic Controller) I/O case 8 will now be described.

As shown in FIG. 1, the PLC I/O case 8 is provided with a case body 11 (functioning as a first component) and a lid 11L (functioning as a second component) which covers an opened side of the case 11.

In FIG. 1, a part (a) shows a plan view of the case body 11 with no lid thereon, a part (b) shows a plan view of the lid 11L, a part (c) shows an enlarged partial plan view of the case body 11 with the lid 11L thereon, and a part (c) shows aside view of the case body 11 taken along a 1A-1A line. A longitudinal circulating direction LD can be dawn in FIG. 1 such that the sealing structure is formed on and along a circulating edge of the case 8, as will be detailed later.

The case body 11 (the first component) is formed as a rectangular prism with one side open. Inside the case body 11, a space 13 is provided to house electronic components constituting the PLC I/O circuit PT (i.e., a substrate etc., which is omitted from being drawn in (a) of FIG. 1). The case body 11 features female threaded portions 12 (threads omitted) for engaging with male threads 11M on the lid 11L (the second component) to assemble the lid 11L to the case body 11. The case body 11 and the lid 11L are formed from materials such as engineering plastics (e.g., polybutylene terephthalate), aluminum, and/or iron.

A peripheral edge portion 13A is provided to form the edge of the opening 13 of the case body 11, and a formation surface 15, upon which the liquid gasket 20 is formed after curing, is provided around the entire circumference of the peripheral portion 13A. The formation surface 15 is thus formed annularly around the peripheral edge portion 13A of the opening 13. A side wall portion 17 is formed around the entire circumference of the outer peripheral edge of the formation surface 15. The side wall portion 17 is thus formed annularly on the outer peripheral edge of the formation surface 15.

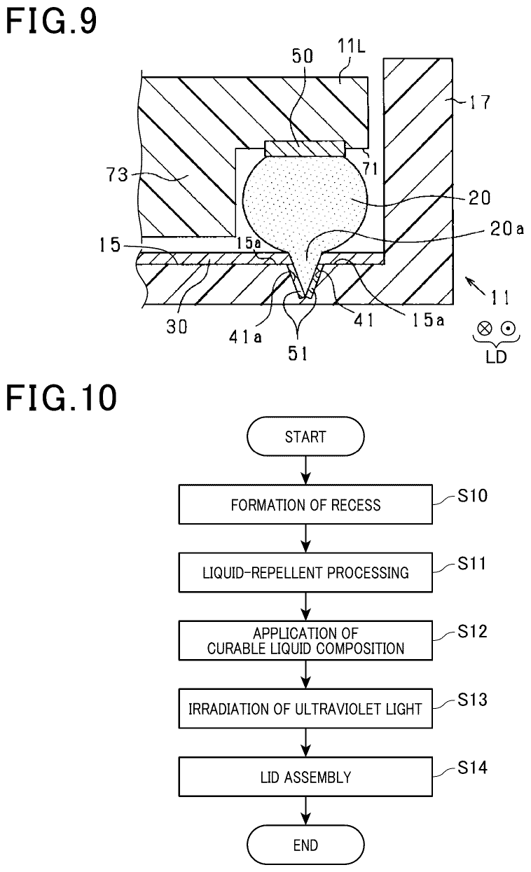

As shown in FIGS. 1 and 9, a cured liquid gasket 20 is formed so as to be located on the inner side of the side wall portion 17 on the formation surface 15. In the present embodiment, the cured liquid gasket 20 is, for example, a silicone gel and is made of a UV-curable silicone composition (curable liquid composition). The ultraviolet-curable silicone compositions include, for example, a composition comprising a polyorganosiloxane having (meth)acrylic groups and a radical-type photoinitiator, or a composition comprising a polyorganosiloxane having epoxy groups and a photocationic catalyst, but is not limited to these compositions.

The opening 13 of the case body 11 is then sealed with the lid 11L, and a male thread is screwed into each of female threaded portions 12. This causes the cured liquid gasket 20 to be compressed between the case body 11 and the lid 11L, thus sealing the space between the case body 11 and the lid 11L. The case body 11, the cured liquid gasket 20, and the lid 11L together constitute the sealing structure.

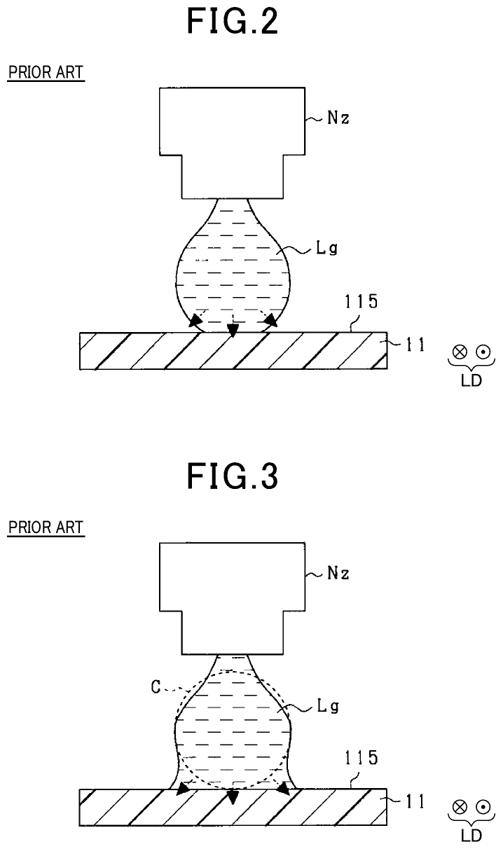

FIG. 2 is a diagram illustrating the prior art, showing a schematic representation of a method for applying a curable liquid composition Lg onto a formation surface 115 (serving as a surface to be coated). The curable liquid composition Lg is dispensed from the coating nozzle Nz of the coating apparatus, whilst the coating nozzle Nz is moved along the formation surface 115. Before the coating processing, the formation surface 115 remains in its molded state and has not undergone any special surface processing.

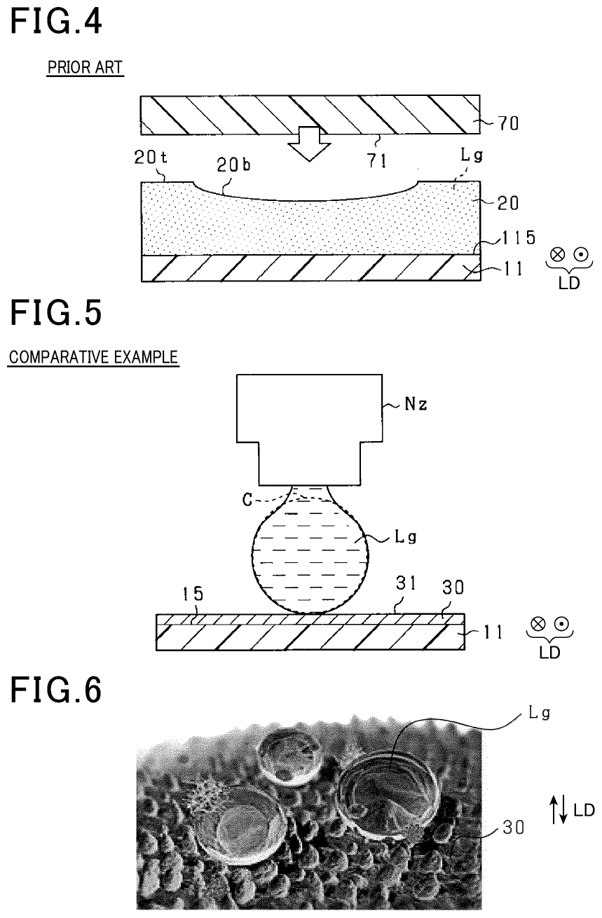

As shown in FIG. 3, according to the prior art, the curable liquid composition Lg applied to the formation surface 115 spreads over the formation surface 115 prior to curing, depending on the wettability of the curable liquid composition Lg with respect to the formation surface 115. A dashed circle C is depicted in FIG. 3, which represents the state where the curable liquid composition Lg has not spread over the formation surface 115. In the prior art, variations in the extent to which the curable liquid composition Lg spreads over the formation surface 115 (i.e., the degree of spreading) occur due to variations in the wettability caused by variations in the surface conditions of the formation surface 115. Consequently, as shown in FIG. 4, variations occur in the height of the curable liquid composition Lg (i.e., the height differs in each part on the formation surface 115), and consequently, variations occur in the height of the cured liquid gasket 20 depending on the locations on the formation surface 115.

FIG. 4 is also a figure illustrating the prior art, and is a schematic diagram explaining a mode of compressing the cured liquid gasket 20. As shown in this figure, the variations in height of the cured liquid gasket 20 form a recess 20b, and the height of the recess 20b is lower than that of the uppermost surface 20t. Thus, between the formation surface 115 of the case body 11 and the opposing surface 71 of a lid 70, when the cured liquid gasket 20 is compressed, the recess 20b may not be sufficiently compressed, potentially reducing sealing performance.

In order to resolve the foregoing insufficient compression, a countermeasure such as that shown in FIG. 5 is envisaged. In this countermeasure, it is envisaged that a liquid-repellent layer 30 is formed on the surface of the case body 11 (i.e., liquid-repellent processing is performed) such that this liquid-repellent layer 30 is configured to repel the curable liquid composition Lg. The liquid-repellent layer 30 is, for example, a layer on which a water-repellent (liquid-repellent) grains have been formed (a layer subjected to graining processing), as shown in FIG. 6. According to this layer configuration, it may be possible to suppress the spreading of the curable liquid composition Lg on the surface 31 of the liquid-repellent layer 30, thereby may suppressing variations in the height of the curable liquid composition Lg depending on locations thereon. By way of example, the liquid-repellent layer 30 may be a fluoropolymer layer formed by fluoropolymer coating, etc.

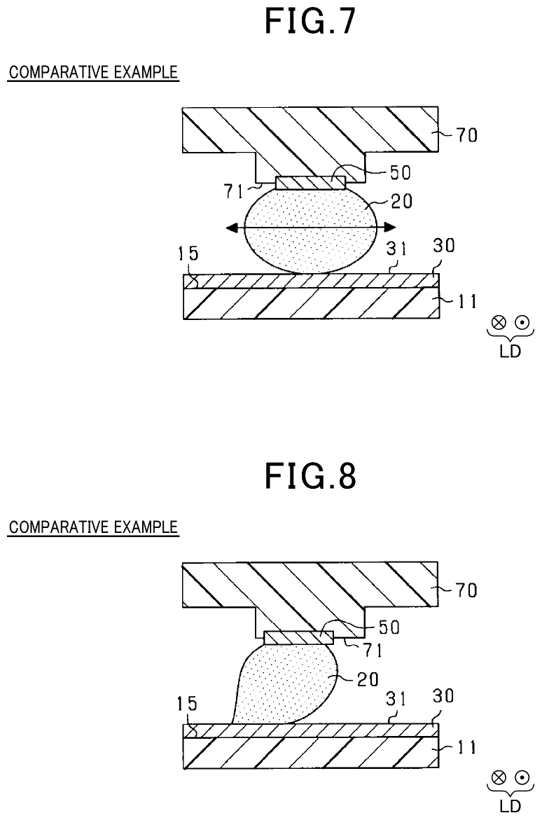

Similarly to FIG. 5, FIG. 7 shows a comparative example, in which the surface 31 was formed on the liquid-repellent layer 30 by coating, and illustrates a state in which the cured liquid gasket 20 is compressed. The opposing surface 71 of the lid 70 remains in its molded state without undergoing special processing (special processing such as graining), functioning as a non-liquid-repellent portion. The cured liquid gasket 20 exhibits high adhesive properties. Thus, the contact area between the upper portion of the liquid gasket 20 and the opposing surface 71 of the lid 70 forms an adhered section 50 where the upper portion of the liquid gasket 20 and the opposing surface 71 of the lid 70 adhere closely. In contrast, the liquid-repellent layer 30 exhibits low adhesion. Hence, the contact area between the lower portion of the liquid gasket 20 and the liquid-repellent layer 30 does not adhere tightly, and no adhered portion is formed.

Therefore, if the cured liquid gasket 20 repeatedly expands and contracts due to temperature changes, or if vibration or impact is applied to the cured liquid gasket 20, there is a risk that the cured liquid gasket 20 may move, as illustrated in FIG. 8. In such cases, it may become impossible to sufficiently compress the cured liquid gasket 20, potentially reducing the sealing performance between the case body 11 and the lid 70.

### Detailed Description of the Sealing Structure According to the First Embodiment

Therefore, in the first embodiment, in view of the various insufficient pressing structures described above, the structure shown in FIG. 9 is adopted. According to this structure, a groove-like recess 41 is formed on and in the case body 11. The recess 41 extends along the annular side wall portion 17 shown in FIG. 1 and is formed annularly on the inner circumferential side of the side wall portion 17 on the formation surface 15. That is, the recess 41 is formed at the position on the formation surface 15 where the cured liquid gasket 20 is located. The cross-sectional shape of the concave surface 41a of the recess 41 (a cross-section intersecting the longitudinal circulating direction LD of the recess 41) is V-shaped. The entire concave surface 41a (or at least a portion thereof) remains in its molded state, without undergoing liquid-repellent processing (i.e., specialized treatment such as graining), and acts as a non-liquid-repellent portion.

In the case body 11, the opening of the recess 41 has a peripheral edge portion 15a, and a liquid-repellent layer 30 (i.e., liquid-repellent portion) is formed on this peripheral edge portion 15a and has a thickness of 0.005 to 0.02 mm, for example. The liquid-repellent layer 30 is formed over at least an area where the liquid gasket 20 is formed, excluding the area where the recess 41 is formed on the formation surface 15. That is, the case body 11 is provided with a liquid-repellent layer 30, which is the portion subjected to the liquid-repellent processing, and a recess 41 (i.e., a non-liquid-repellent portion), which is the portion not subjected to the liquid-repellent processing. In addition, the portions of the case body 11 other than those where the liquid-repellent layer 30 is provided remain in their as-molded state and have not undergone the liquid-repellent processing (serving as special processing).

The cured liquid gasket 20, as shown in FIG. 9, has a lower portion 20a which is positioned to enter into the recess 41. In other words, the lower portion 20a thereby fills the interior of the recess 41. Hence, it can be said that the lower portion 20a of the cured liquid gasket 20 is formed to be immersed within the recess 41 from the opening of the recess 41, while the remaining portion of the curried liquid gasket 20 is formed to protrude outside the recess 41. The cured liquid gasket 20 is made as one body, so that the lower portion 20a of the cured liquid gasket 20 acts as a fixed (or locked) portion between the cured liquid gasket 20 and the recess 41. The lower portion 20a (i.e., the fixed portion) provides a wedging effect which makes it possible that the cured liquid gasket 20 resists moving from the recess 41.

The lid 11L possesses an opposing surface 71 which can be defined as a surface to be opposed to the cured liquid gasket 20 when being compressed, so that the opposing surface 71 is able to serve as a surface compressing the cured liquid gasket 20, and this opposing surface 71 remains in its molded state. That is, this opposing surface 71 has not undergone the liquid-repellent processing (which is called special processing in the current embodiment). Moreover, the portions of the lid 11L other than the opposing surface 71 are also in their as-molded state and have not undergone the liquid-repellent processing (i.e., the special processing).

The opening 13 of the case body 11 is then sealed with the lid 11L, and the male threads are screwed into the female threaded portions 12. Accordingly, the cured liquid gasket 20 is compressed between the case body 11 and the lid 11L, thus providing a sealing performance between the case body 11 and the lid 11L using the liquid gasket 20, thereby forming the sealing structure according to the present embodiment.

The cured liquid gasket 20 possesses high adhesive properties. Hence, the contact area where the upper portion of this cured liquid gasket 20 (liquid gasket) and the opposing surface 71 of the lid 11L mutually contact each other forms an adhered portion 50, where the upper portion of the liquid gasket 20 and the opposing surface 71 of the lid 11L are tightly adhered. Meanwhile, the contact area where the lower portion 20a of the liquid gasket 20 and the concave surface 41a of the recess 41 of the case body 11 mutually contact each other forms an adhered portion 51, where the lower portion 20a of the liquid gasket 20 and the concave surface 41a of the recess 41 adhere closely together. Incidentally, both of the adhered portions 50 and 51 are layered portions in which molecules of both of the gasket and lid or case body are mixed and combined with each other by the compression. These adhered portions 50 and 51 operate to hold the cured liquid gasket 20 therebetween, so that the cured liquid gasket 20 is almost fixed and prevented from moving.

The adhered portions 50 and 51, which act as fixing means, can therefore be combined with the lower portion 20a providing the wedging effect in order to strengthen the resistance performance of the cured liquid gasket 20 against the movement thereof.

In addition, at the peripheral edge portion 15a of the opening of the recess 41, the liquid-repellent layer 30 and the cured liquid gasket 20 are in contact with each other. That is, the cured liquid gasket 20 contacts both the liquid-repellent layer 30 (i.e., the liquid-repellent portion) and the concave surface 41a (i.e., the non-liquid-repellent portion) of the recess 41. Moreover, the cured liquid gasket 20 may or may not be in contact with the side wall portion 17. The area where the cured liquid gasket 20 and the side wall portion 17 are in contact serves as the sealing portion. Furthermore, the cured liquid gasket 20 and the inner wall portion 73 extending from the lid 11L need not be in contact or may be in contact with each other. The area where the cured liquid gasket 20 and the inner wall portion 73 are in contact serves as the sealing portion.

FIG. 10 is a flowchart illustrating the manufacturing method for the sealing structure. The sequence of processes, shown in FIG. 10, may be performed automatically by production equipment, or manually by an operator controlling the production equipment. Furthermore, this sequence of processes may include both automatically performed processes and manually performed processes.

First, a recess 41 is formed on the formation surface 15 of the case body 11 (step S10). The recess 41 (i.e., a non-liquid-repellent portion) may be integrally formed with the side wall portion 17 and the like, during the molding of the case body 11, or it may be formed after the molding of the case body 11 by machining or the like. The concave surface 41a of the recess 41 is left in its as-molded state and no liquid-repellent processing (special processing) is performed. That is, the entire concave surface 41a of the recess 41 (or at least a portion thereof) is made into a non-liquid-repellent portion.

Subsequently, a liquid-repellency layer 30 (i.e., the liquid-repellent portion) is formed by using graining processing (i.e., liquid-repellent processing) (step S11). Within the area where the cured liquid gasket 20 is formed, the graining processing is not applied to the recess 41. Conversely, the graining processing is applied to the area including the peripheral edge portion 15a of the opening of the recess 41. Moreover, the liquid-repellency layer 30 (i.e., the liquid-repellent portion) may be integrally formed together with the side wall portion 17 and the like, during the molding of the case body 11, or it may be processed after the molding of the case body 11.

A curable liquid composition Lg is then applied to a predetermined area including the groove-like recess 41 on the formation surface 15 of the case body 11 (step S12). Specifically, the curable liquid composition Lg is applied annularly along the annular recess 41. During this application, the groove-shaped recess 41 is utilized as a type of positioning marker to determine the position at which the curable liquid composition Lg is applied. The curable liquid composition Lg in contact with the concave surface 41a of the recess 41 spreads over the concave surface 41a. Meanwhile, the curable liquid composition Lg in contact with the liquid-repellent layer 30 is repelled by the liquid-repellent layer 30. As a result, the height of the curable liquid composition Lg is suppressed or reducing from varying.

As the next step, ultraviolet light is irradiated onto the applied curable liquid composition Lg for curing thereof (step S13). The time interval from completion of applying the curable liquid composition Lg to competition of irradiating this composition Lg with ultraviolet light for curing, which includes a net irradiation interval of the ultraviolet, is, for example, several tens of seconds. This results in the formation of the cured liquid gasket 20.

The lid 11L is then assembled onto the case body 11 (step S14). Specifically, the opening 13 of the case body 11 is covered by the lid 11L, and male threads are screwed into female threaded portions 12. This compresses the cured liquid gasket 20 between the case body 11 and the lid 11L, thus causing the cured liquid gasket 20 to adhere closely to both the opposing surface 71 of the lid 11L and the concave surface 41a of the case body 11. As a result of this compression, the case body 11 and the lid 11L are closely and seamlessly connected with each other by the liquid gasket 20, thereby producing the sealing structure.

The present embodiment described in detail above has the following advantages.

First, the case body 11 includes the liquid-repellent layer 30 formed by the liquid-repellent processing. In addition, as the cured liquid gasket 20 is in contact with the liquid-repellency layer 30 when the curable liquid composition Lg is applied to the case body 11, the curable composition Lg in contact with the liquid-repellency layer 30 is repelled by the liquid-repellency layer 30. Hence, the spread of the applied curable liquid composition Lg across the formation surface 15 of the case body 11 is suppressed before curing, thereby preventing or reducing variations in the height of the curable composition Lg. As a result, variations in the thickness of the cured liquid gasket 20 are suppressed or reduced significantly. This enables the cured liquid gasket 20 to be uniformly compressed between the case body 11 and the lid 11L, thereby improving the sealing performance of the sealing structure.

Secondly, the case body 11 is formed with the recess 41 that has not undergone the liquid-repellent processing. In addition to this, the cured liquid gasket 20 is in contact with the concave surface 41a of the recess 41. Thus, even if the adhesion between the liquid-repellency layer 30 and the cured liquid gasket 20, which is caused by being compressed between the case body 11 and the lid 11L, deteriorates, the adhesion between the concave surface 41a of the recess 41 and the cured liquid gasket 20 can be maintained at a high level. Hence, movement of the cured liquid gasket 20 relative to the case body 11 can be suppressed or reduced, and the cured liquid gasket 20 can be sufficiently compressed between the case body 11 and the lid 11L to ensure higher sealing performance.

In addition, the adhered portions 50 and 51 act as fixing means so as to hold the cured liquid gasket 20, so that the cured liquid gasket 20 is almost fixed and prevented from moving. These fixing means can be combined with the lower portion 20a providing the wedging effect. Thus, the resistance performance of the cured liquid gasket 20 against the movement thereof can be strengthened.

Thirdly, the opposing surface 71 of the lid 11L which presses the cured liquid gasket 20 is not subjected to the liquid-repellent processing. This configuration enables a high degree of adhesion between the opposing surface 71 pressed to the cured liquid gasket 20 and the cured liquid gasket 20 itself, thereby suppressing movement of the cured liquid gasket 20 relative to the lid 11L. Hence, the cured liquid gasket 20 can be sufficiently compressed between the case body 11 and the lid 11L, thereby ensuring a higher sealing performance in the sealing structure.

The fourth advantage results from a portion of the cured liquid gasket 20 which is positioned in the groove-like recess 41, whilst the remaining portion of the cured liquid gasket 20 is positioned outside the recess 41. Hence, when the cured liquid gasket 20 is forced to attempt to move relative to the case body 11, the lower portion 20a of the cured liquid gasket 20 positioned to impinge into the recess 41 is caught in the recess 41, thereby preventing or reducing movement of the cured liquid gasket 20.

The sixth advantage can be provided by the configuration in which the non-liquid-repellent portion is formed across the entire concave surface 41a of the case body 41. Thus, compared to a case where the non-liquid-repellent portion is formed on only the flat surface, the spread of the applied curable liquid composition Lg on the formation surface 15 of the case body 11 can be suppressed. Therefore, variations in the height of the curable composition Lg, and consequently variations in the thickness of the cured liquid gasket 20, can be further suppressed.

The seventh advantageous effect can be provided such that when determining the position for applying the curable liquid composition Lg, the groove-like recess 41 can be utilized. This improves the workability when applying the curable liquid composition Lg.

The eight advantageous effects are provided by the configuration where the liquid-repellent layer 30 is formed on the peripheral edge portion 15a of the opening of the recess 41. According to this configuration, when applying the curable liquid composition Lg to the case body 11, a portion of the curable liquid composition Lg which drips outside the recess 41 is more readily repelled by the liquid-repellency layer 30 formed on the peripheral edge portion 15a of the opening of the recess 41. Consequently, the height of the curable liquid composition Lg can be reduced on the case body 11, thereby suppressing variations in its height. This further suppresses variations in the thickness of the cured liquid gasket 20.

As the ninth advantage, there can be provided the configuration in which the cross-sectional shape of concave surface 41a is V-shaped, and the entire concave surface 41a constitutes a non-liquid-repellent portion. This configuration enables the application of the curable liquid composition Lg whilst minimizing the amount of the curable composition Lg flowing into the recess 41, and simultaneously ensuring the contact area between cured liquid gasket 20 and the non-liquid-repellent portion. Consequently, it is possible to suppress movement of the cured liquid gasket 20 due to the portion locked by the recess 41, whilst further reducing the height of the curable liquid composition Lg, thereby further suppressing variations in the height of the curable composition Lg.

The tenth average is that the curable liquid composition Lg is applied to a predetermined area containing the liquid-repellent layer 30 on the case body 11. Hence, the curable composition Lg in contact with the liquid-repellent layer 30 is repelled by the liquid-repellency layer 30. Therefore, it is possible to suppress the spread of the applied curable liquid composition Lg on the formation surface 15 of the case body 11 before it hardens, thereby suppressing variations in the height of the curable composition Lg.

The applied curable composition Lg is then cured to form the cured liquid gasket 20. During this curing, as variations in the height of the curable composition Lg is suppressed, variations in the thickness of the cured liquid gasket 20 can also be suppressed or reduced.

After the curing processing, the cured liquid gasket 20 is compressed between the case body 11 and the lid 11L, thus adhering the cured liquid gasket 20 to the concave surface 41a (i.e., the non-liquid-repellent portion) of the case body 11. At this stage, as variations in the thickness of the cured liquid gasket 20 has been suppressed or reduced, the cured liquid gasket 20 can be uniformly compressed between the case body 11 and the lid 11L, thereby providing a higher sealing performance to the sealing structure. Furthermore, even if the adhesion between the liquid-repellent layer 30 and the cured liquid gasket 20 deteriorates, the adhesion between the concave surface 41a and the cured liquid gasket 20 can be maintained at a high level. As a result, movement of the cured liquid gasket 20 relative to the case body 11 can be suppressed or reduced significantly, thereby enabling the cured liquid gasket 20 to be sufficiently compressed between the case body 11 and the lid 11L, thereby ensuring a higher sealing performance.

Moreover, the non-liquid-repellent portion is formed across the entire concave surface 41a of the groove-shaped recess 41, and the curable liquid composition Lg is applied in a predetermined range containing this non-liquid-repellent portion. Hence, the grooved recess 41 can be utilized as a positioning marker when determining the location for applying the curable liquid composition Lg, thereby improving the workability during application of the curable liquid composition Lg. Furthermore, compared to when a non-liquid-repellent portion is formed on a flat surface, the spread of the applied curable liquid composition Lg on the formation surface 15 of the case body 11 can be suppressed or reduced steadily. Consequently, variations in the height of the curable composition Lg and consequently variations in the thickness of the cured liquid gasket 20 can be further suppressed.

In the manufacturing process according to the present embodiment, the liquid-repellent layer 30 is formed on the peripheral edge portion 15a of the opening of the recess 41. According to this process, when applying the curable liquid composition Lg to the case body 11, the portion of the curable liquid composition Lg that drips outside the recess 41 is more readily repelled by the liquid-repellency layer 30 formed on the peripheral edge portion 15a of the opening of the recess 41. The height of the curable liquid composition Lg can thus be reduced, thereby suppressing variations in the height of the curable liquid composition Lg. This further suppresses or removes variations in the thickness of the cured liquid gasket 20.

The sealing structure according to the first embodiment may be implemented with the following modifications. For components identical to those in the first embodiment, the same reference numerals or numbers are used to incorporate their description by reference.

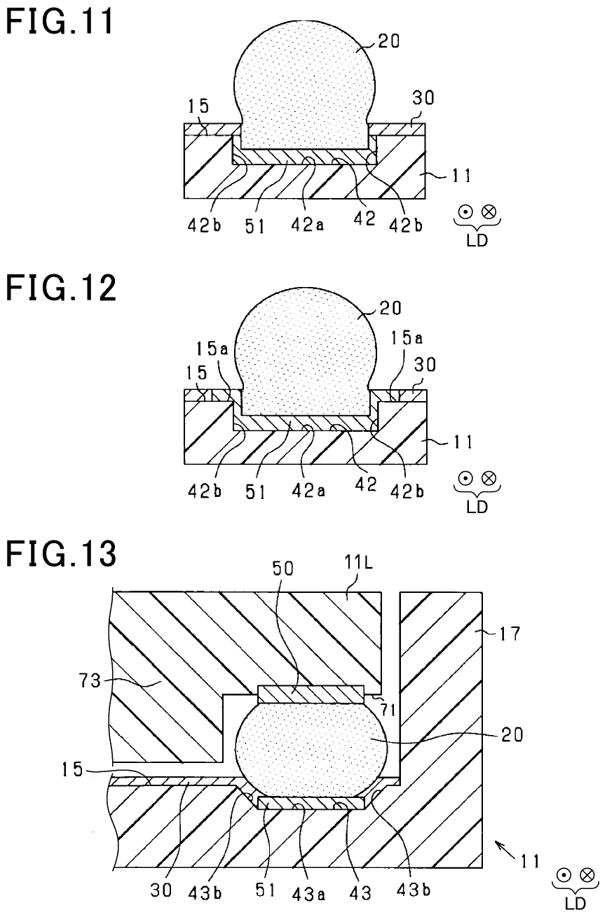

FIG. 11 shows a modification, in which a groove-shaped recess 42 may be formed on the case body 11. The concave surface of the recess 42 includes a bottom surface 42a and side surfaces 42b, that is, the section of the recess 42 across its longitudinal circulating direction LD is a square or rectangular. The entire bottom surface 42a and side surfaces 42b (or at least part of the concave surface) remain in their molded state, without undergoing the liquid-repellent processing, and thus constitute a non-liquid-repellent portion. In this configuration, when the curable liquid composition Lg is applied along the recess 42, the curable liquid composition Lg in contact with the bottom surface 42a and side surface 42b of the recess 42 spreads on the bottom surface 42a and side surfaces 42b. Conversely, the curable liquid composition Lg contacting the liquid-repellency layer 30 is repelled by the liquid-repellency layer 30. This suppresses variations in the height of the curable liquid composition Lg. Then, when the cured liquid gasket 20 is compressed between the case body 11 and the lid 11L, the contact areas between the liquid gasket 20 and the bottom surface 42a and side surfaces 42b of the recess 42 provide adhered areas 51, where the liquid gasket 20 adheres closely to the bottom surface 42a and side surfaces 42b. Consequently, this configuration also achieves the advantageous effects corresponding to those gained by the first embodiment.

FIG. 12 shows another modification, in which the entire bottom surface 42a and side surfaces 42b, together with the peripheral edge portion 15a of the opening of the recess 42, may be left in their molded state without undergoing the liquid-repellent processing (special treatment), thereby forming a non-liquid-repellent portion. In this case, when the curable liquid composition Lg is applied along the recess 42, the curable liquid composition Lg in contact with the bottom surface 42a, side surfaces 42b, and peripheral edge portion 15a of the recess 42 will spread on the bottom surface 42a, side surfaces 42b, and peripheral edge portion 15a. Conversely, the curable liquid composition Lg in contact with the liquid-repellency layer 30 is repelled by the liquid-repellent layer 30. Consequently, variations in the height of the curable liquid composition Lg is suppressed. Furthermore, when the cured liquid gasket 20 is compressed between the case body 11 and the lid 11L, the contact areas between the liquid gasket 20 and the bottom surface 42a, side surfaces 42b, and peripheral edge portion 15a of the recess 42 are able to provide areas where the liquid gasket 20 adheres closely to the bottom surface 42a, side surfaces 42b, and peripheral edge portion 15a, thus forming an adhered portion 51. Consequently, this configuration also achieves advantageous effects equivalent to those gained by the first embodiment.

### Second Embodiment

With reference to FIG. 13, a second embodiment of the sealing structure according to the present disclosure will now be described.

In this embodiment, as shown in FIG. 13, a recess 43 with a trapezoidal cross-sectional shape across the longitudinal circulating direction LD thereof is formed on the case body 11, and a liquid-repellent layer 30 is formed up to the side surfaces 43b of the recess 43. The other configurations are the same as those explained in the first embodiment. For parts identical to those in the first embodiment, the same reference numerals or numbers are used to incorporate their descriptions by reference.

The concave surface of recess 43 includes a bottom surface 43a and side surfaces 43b. The bottom surface 43a (i.e., at least, serving as a part of the concave surface) remains in its molded state without undergoing the liquid-repellent processing, thus constituting a non-liquid-repellent portion. The side surfaces 43b have undergone the liquid-repellent processing, thus forming a liquid-repellency layer 30. In this configuration, when a curable liquid composition Lg is applied along the recess 43, the curable liquid composition Lg in contact with the bottom surface 43a of the recess 43 spreads on the bottom surface 43a. Conversely, the curable liquid composition Lg contacting the liquid-repellent layer 30 is repelled by the liquid-repellency layer 30. This suppresses variations in the height of the curable liquid composition Lg. As the next step, the cured liquid gasket 20 is compressed between the case body 11 and the lid 11L. Due to this compression, the contact area between the liquid gasket 20 and the bottom surface 43a of the recess 43 provides an adhered area 51 where the liquid gasket 20 and the bottom surface 43a adhere closely. Hence, this configuration also achieves the same functional effects as those stated in the first embodiment.

Furthermore, in this example, the liquid-repellency layer 30 is formed on the side surfaces 43b of the concave surface. For this reason, when applying the curable liquid composition Lg to the case body 11, the curable liquid composition Lg is readily repelled by the liquid-repellency layer 30 formed on the side surfaces 43b of the concave surface. The height of the curable liquid composition Lg can be further suppressed, thereby also reducing variations in its height. In other words, variations in the thickness of the cured liquid gasket 20 can be further suppressed.

### Third Embodiment

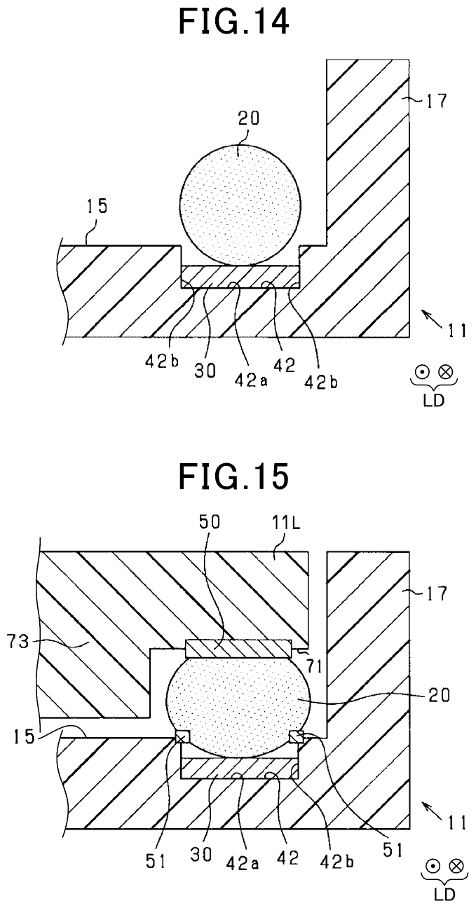

With reference to FIGS. 14 and 15, a third embodiment of the sealing structure according to the present disclosure will now be described.

In this embodiment, as shown in FIG. 14, a groove-shaped recess 42 is formed in the case body 11. The groove-shaped recess 42 has a rectangular or square cross section when being sectioned across the longitudinal circulating direction LD thereof, so that the concave surface of the recess 42 has a bottom surface 42a and side surfaces 42b. The upper portions of the side surfaces 42b (i.e., at least, serving as a part of the concave surface) remain in its as-molded state, without undergoing the liquid-repellent processing, and constitutes a non-liquid-repellent portion.

A liquid-repellent layer 30 is formed on the bottom surface 42a by liquid-repellent processing. The width of the bottom surface 42a is such that the cured liquid gasket 20 does not contact the periphery of the opening of the recess 42, prior to compression. That is, a spatial gap is left between the periphery of the opening of the recess 42 and the cured liquid gasket 20, prior to compression. Furthermore, the formation surface 15 remains in its molded state and has not undergone the liquid-repellent processing (i.e., special processing in the present embodiment), constituting a non-liquid-repellent portion. Other configurations are identical to those stated in the first embodiment.

For components identical to those in the first embodiment, the same reference numerals or numbers are used to incorporate their descriptions.

In this configuration, when the curable liquid composition Lg is dripped along the recess 42, the curable liquid composition Lg is repelled by the liquid-repellency layer 30 and does not come into contact with the side surfaces 42b of the recess 42 or the formation surface 15. Hence, variations in the height of the curable liquid composition Lg is suppressed or reduced remarkably. Then, as shown in FIG. 15, the case body 11 and the lid 11L compress the cured liquid gasket 20. Due to this compression, the contact area between the liquid gasket 20 and the periphery of the opening of the recess 42 becomes adhered portions 51 where the liquid gasket 20 and the periphery of the opening of the recess 43 adhere closely. Accordingly, this configuration also achieves the advantageous effects equivalent to those stated in the first embodiment.

In addition, a non-liquid-repellent portion is formed on the side surfaced 42b of the concave surface. Thus, when the cured liquid gasket 20 attempts to move relative to the case body 11, portions of the compressed cured liquid gasket 20 are made to adhere to the non-liquid-repellent portion formed on the side surfaces 42b of the concave surface. Therefore, movement of the cured liquid gasket 20 can be suppressed or reduced.

### Fourth Embodiment

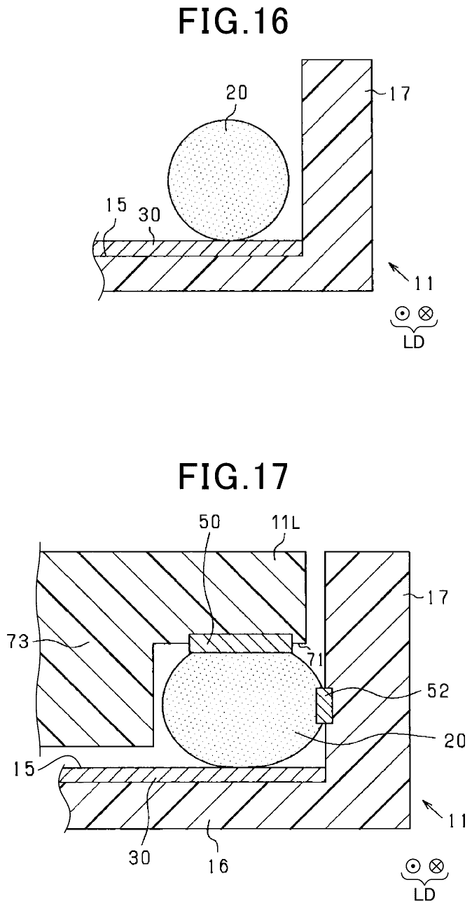

With reference to FIGS. 16 and 17, a fourth embodiment of the sealing structure according to the present disclosure will now be described.

As shown in FIG. 16, in the sealing structure of this embodiment, no recess is formed in the formation surface 15. The other configurations are identical to those set forth in the third embodiment. For parts or components identical to those in the third embodiment, the same reference numerals or numbers are used to incorporate their description by reference.

In this structure, when the curable liquid composition Lg is dispensed onto the formation surface 15, the composition Lg is repelled by the liquid-repellency layer 30. Thus, variations in the height of curable liquid composition Lg on the formation surface 15 are suppressed. In addition, in this dispensing step, the curable liquid composition Lg is dispensed so as not to come into contact with the side wall portion 17 of the case body 11.

As shown in FIG. 17, when the cured liquid gasket 20 is compressed between the case body 11 and the lid 11L, the contact area between the liquid gasket 20 and the side wall portion 17 forms an adhered portion 52 where the liquid gasket 20 and the side wall portion 17 adhere closely together. Therefore, this configuration also achieves the same functional effects as those set forth in the first embodiment. Moreover, the cured liquid gasket 20 may or may not contact the inner wall portion 73 extending from the lid 11L. The part where the cured liquid gasket 20 contacts the inner wall portion 73 provides an adhered portion.

Concretely, the case body 11 is provided with a first portion 16 facing the cured liquid gasket 20 in a first direction (i.e., the vertical direction) in which the cured liquid gasket 20 is compressed, and a side wall portion 17 (i.e., the second portion) extending from the first portion 16 in a second direction (i.e., the horizontal direction) perpendicular to the first direction and facing the cured liquid gasket 20. Moreover, a liquid-repellency layer 30 is formed on the first portion 16, and a non-liquid-repellent portion is formed on the side wall portion 17.

According to the above configuration, even if the adhesion between the liquid-repellency layer 30 formed in the first portion 16 and the cured liquid gasket 20, which is compressed between the case body 11 and the lid 11L, deteriorates, it is possible to maintain a high adhesion performance between the non-liquid-repellent portion formed in the side wall portion 17 and the cured liquid gasket 20. Hence, movement of the cured liquid gasket 20 relative to the case body 11 can be suppressed, thereby enabling the cured liquid gasket 20 to be sufficiently compressed between the case body 11 and the lid 11L to ensure a higher and reliably sealing performance.

The first to fourth embodiments can be modified as follows. In the following modifications, the same or identical components as or to those explained in the first to fourth embodiments are given the same reference numbers.

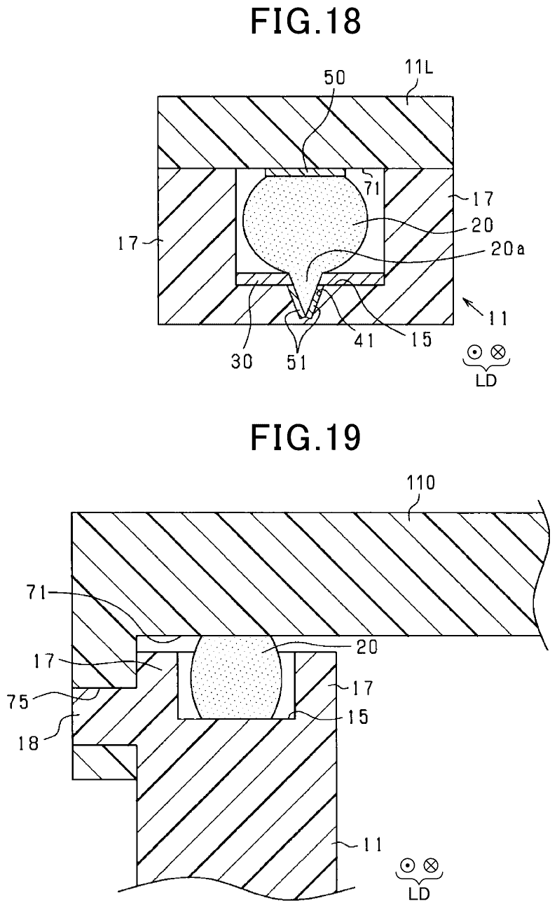

FIG. 18 explains a modification, the case body 11 has a pair of side wall portions 17. The two side wall portions 17 face each other. A cured liquid gasket 20 is positioned between the two side wall portions 17. The cured liquid gasket 20 is compressed between the formation surface 15 of the case body 11 and the opposing surface 71 of the lid 11L. This configuration also achieves the same or identical effect as that shown in the first embodiment. It is noted that the cured liquid gasket 20 may or may not be in contact with the side wall portions 17. The area where the cured liquid gasket 20 and each of the side wall portions 17 are in contact provides a sealing section. Furthermore, while FIG. 18 shows the application of the case body 11 and lid 11L of the first embodiment, the case body 11 and lid 11L shown in FIG. 18 can also be applied to the second to fourth embodiments. In such modifications, the same operational effects as those gained in the second to fourth embodiments can also be achieved.

FIG. 19 shows another modification, in which holes 75 may be formed through the edge of a lid 110, and protrusions 18 may be formed on the case body 11 to engage with holes 75. Furthermore, the configuration may involve compressing the cured liquid gasket 20 between the formation surface 15 of the case body 11 and the opposing surface 71 of the lid 11L, by engaging the protrusions 18 with the holes 75 (which is referred to as a snap-fit). It is noted that in FIG. 19, the indications for the liquid-repellent portion and non-liquid-repellent portion are omitted.

The configuration shown in FIG. 19 may be applied to that set forth in the first to fourth embodiments. Furthermore, at least part of the opposing surface 71 of the lid 11L, which is the surface compressing the cured liquid gasket 20, may be left in its as-molded state without undergoing the liquid-repellent processing (i.e., the special processing in the present disclosure). That is, the opposing surface 71 of the lid 11L, which is the surface compressing the cured liquid gasket 20, may include a portion that has undergone the water-repellent processing.

The curable composition Lg forming the liquid gasket 20 may employ not only UV-curable silicone compositions but also photopolymerisable silicone compositions other than UV-curable types, such as those containing polyorganosiloxanes with vinyl siloxane groups, polythiol compounds, and radical-type photoinitiators.

The curable composition Lg forming the liquid gasket 20 may adopt not only a light-curable composition but also a thermosetting composition or a moisture-curable composition. Even when applying one of these curable compositions Lg to the embodiments and their modified examples, it is also possible to suppress the spread of the applied curable liquid composition Lg on the surface of the first component before curing the curable compositions, thereby suppressing variations in the height of the curable composition Lg on the surface. Consequently, it is possible to reduce or remove variations in the thickness of the cured liquid gasket 20.

Each embodiment and its variations may be applied not only to PLC I/O cases but also to various waterproof (liquid-proof) cases. For example, such waterproof (liquid-proof) cases may also be used to house electronic control units (ECUs), battery packs, cameras, rangefinders, sensors, and the like.

### PARTIAL REFERENCE NUMBER LIST

11 . . . case body (first component)
20 . . . cured liquid gasket
30 . . . liquid-repellent layer (liquid-repellent portion)
41a . . . concave surface (non-liquid-repellent portion)
11L . . . lid (second component)

What is claimed is:

1. A sealing structure provided for a first component and a second component such that the first and second components are sealed by being tightly contacted with each other, wherein
the first component is provided with a cured liquid gasket, the cured liquid gasket being compressed between the first and second components,
the first component is provided with a liquid-repellent portion (30) which is subjected to liquid-repellent processing and a non-liquid-repellent portion (41a) which is not subjected to the liquid-repellent processing, and
the cured liquid gasket is in touch with both the liquid-repellent portion and the non-liquid-repellent portion when being compressed.

2. The sealing structure according to claim 1, wherein the second component is provided with a portion which compresses the cured liquid gasket, the portion including, at least, a part which is not subjected to the liquid-repellent processing.

3. The sealing structure according to claim 1, wherein
the first component is formed with a groove-shaped recess thereon,
the cured liquid gasket has a part which is disposed in the recess and a remaining part which is disposed outside the recess, and
the recess has a concave surface at least a part of which is formed with the non-liquid-repellent portion.

4. The sealing structure according to claim 3, wherein the recess has an opening of which peripheral edge portion is formed with the liquid-repellent portion.

5. The sealing structure according to claim 4, wherein the concave surface substantially has a V-shape in section with a longitudinal direction along the recess, and
the concave surface is wholly formed with the non-liquid-repellent portion.

6. The sealing structure according to claim 4, wherein the concave surface has a bottom surface and side surfaces,
the bottom surface is formed with the non-liquid-repellent portion, and
the side surfaces are formed with the liquid-repellent portion.

7. The sealing structure according to claim 3, wherein the concave surface has a bottom surface and side surfaces,
the bottom surface is formed with the liquid-repellent portion, and
the side surfaces are formed with the non-liquid-repellent portion.

8. The sealing structure according to claim 1, wherein
the first component has a first portion and a second portion, the first portion being opposed to the cured liquid gasket in a first direction along which the cured liquid gasket is compressed, the second portion being bent and extended from the first portion and opposed to the cured liquid gasket in a second direction perpendicular to the second direction,
the liquid-repellent portion is formed on the first portion, and the non-liquid-repellent portion is formed on the second portion.

9. A sealing method which manufactures a sealing structure provided for a first component and a second component such that the first and second components are sealed with each other, the sealing method comprising steps of:
forming, on the first component, a liquid-repellent portion which is subjected to liquid-repellent processing and a non-liquid-repellent portion which is not subjected to the liquid-repellent processing;
applying a curable liquid composition to a predetermined area including, at least, a part of the liquid-repellent portion on the first component;
curing the applied curable composition to from the cured liquid gasket;
compressing the cured liquid gasket between the first and second components such that the non-liquid-repellent portion is tightly in touch with the cured liquid gasket.

10. A sealing method according to claim 9, comprising steps of:
forming a groove-shaped recess on the first component, the recess having a concave surface,
forming the non-liquid-repellent portion on, at least, the concave surface of the recess, and
applying the curable liquid composition to the predetermined area including, at least, the part of the non-liquid-repellent portion.

11. A sealing method according to claim 9, comprising a step:
forming the liquid-repellent portion on a peripheral edge portion of an opening of the recess.

12. An electric apparatus, comprising:
a first component provided with a space, an electronic device being housed in the space; and
a sealing structure provided for the first component and the second component such that the first and second components are sealed by being tightly contacted with each other, wherein the first component is provided with a cured liquid gasket, the cured liquid gasket being compressed between the first and second components,
the first component is provided with a liquid-repellent portion which is subjected to liquid-repellent processing and a non-liquid-repellent portion which is not subjected to the liquid-repellent processing, and
the cured liquid gasket is in touch with both the liquid-repellent portion and the non-liquid-repellent portion when being compressed.

13. The electric apparatus according to claim 12, wherein the second component is provided with a portion which compresses the cured liquid gasket, the portion including, at least, a part which is not subjected to the liquid-repellent processing.

14. The electric apparatus according to claim 12, wherein
the first component is formed with a groove-shaped recess thereon,
the cured liquid gasket has a part which is disposed in the recess and a remaining part which is disposed outside the recess, and
the recess has a concave surface at least a part of which is formed with the non-liquid-repellent portion.

15. The electric apparatus according to claim 14, wherein the recess has an opening of which peripheral edge portion is formed with the liquid-repellent portion.

16. The electric apparatus according to claim 15, wherein the concave surface has a V-shape in section with a longitudinal circulating direction along the recess, and
the concave surface is wholly formed with the non-liquid-repellent portion.

17. The electric apparatus according to claim 15, wherein the concave surface has a bottom surface and side surfaces,
the bottom surface is formed with the non-liquid-repellent portion, and
the side surfaces are formed with the liquid-repellent portion.

18. The electric apparatus according to claim 14, wherein the concave surface has a bottom surface and side surfaces,
the bottom surface is formed with the liquid-repellent portion, and
the side surfaces are formed with the non-liquid-repellent portion.

19. The sealing structure according to claim 12, wherein
the first component has a first portion and a second portion, the first portion being opposed to the cured liquid gasket in a first direction along which the cured liquid gasket is compressed, the second portion being bent and extended from the first portion and opposed to the cured liquid gasket in a second direction perpendicular to the second direction,
the liquid-repellent portion is formed on the first portion, and
the non-liquid-repellent portion is formed on the second portion.
